(19) United States
(12) Patent Application Publication
(10) Pub. No.: US 2016/0253352 A1
(43) Pub. Date: Sep. 1, 2016

(54) METHOD AND APPARATUS FOR FILE SYNCHRONIZATION AND SHARING WITH CLOUD STORAGE

(71) Applicant: BARRACUDA NETWORKS, INC., Campbell, CA (US)

(72) Inventors: Aaron KLUCK, Brighton, MI (US); Jason DICTOS, Ypsilanti, MI (US)

(21) Appl. No.: 15/009,685

(22) Filed: Jan. 28, 2016

Related U.S. Application Data
(60) Provisional application No. 62/121,704, filed on Feb. 27, 2015.

(51) Int. Cl. G06F 17/30; H04L 29/08

(52) U.S. Cl. CPC G06F 17/30165; G06F 17/30174; H04L 67/1097

(57) ABSTRACT

A new approach is proposed that contemplates systems and methods to support offline file system synchronization and sharing with cloud storage via a virtual file system (VFS) configured to provide a complete view of all file files/file folders in a user's account. The VFS separates the storage of the files and their metadata into two primary databases—a staging database where local changes to the files are stored and a file database, which is a cloud-synchronized copy of path structure and metadata information of the files and file folders. The VFS first pulls/retrieves the latest version of a file to be modified from the cloud based on metadata in the file DB and updates the locally-stored version of the file based on the version retrieved from the cloud. Once the file is modified by the user locally via a client (even when the client is offline), the VFS commits and consolidates all the changes made by this and possibly other users to the file in the staging DB before synchronizing the changes to the cloud.

### CROSS-REFERENCE TO RELATED APPLICATIONS

This application claims the benefit of U.S. Provisional Patent Application No. 62/121,704, filed Feb. 27, 2015, and entitled “File Synchronization between local staging DB and cloud DB,” which is incorporated herein in its entirety by reference.

### BACKGROUND

For a long time the typical synchronization or sync and share application was defined as a system that is configured to download and upload files automatically to a folder on a desktop or a laptop computing device/machines. With more and more data being stored in the cloud storage these days, local storage allowances become an issue and some of the sync and share applications started to provide methods that provide users control over what is to be downloaded to or uploaded from their local machines/systems.

One design some of the applications have implemented is selective synchronization, which provides the users with a manual selection of what the app will download, or not download to their local machines. The problem with giving such a choice to the users, however, is that the users only know what they want to access when they want to access it. So inevitably there is a delay between when the users decide that they want to access a file and when the file gets downloaded to their local machines. In addition, when the storage space is limited on the local machines, the users must make two choices on what files they no longer wish to store on their local systems, and what they now want to store to replace the files to be deleted. The users must figure out on their own the space allotment of each of these decisions and inevitably this process creates frustration and complexity to their experiences.

Another solution commonly adopted is to provide a web-based view of the files of the users. Directing the users to a website where they can view all their files, however, is also problematic in that no web-based client application can render or edit every file type the users wish to access and large file types such as video and raw images are only suitable for viewing and not editing within the browser.

It is thus desirable to provide a file synchronization approach that overcomes the limitations of the current designs and provides the users with on demand access to all their files using the native applications on their local machines without requiring the files to be stored locally.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support file synchronization and sharing with cloud storage in accordance with some embodiments.

FIG. 2(a)-(b) depict loading parts of a file locally in a context for read and write operations, respectively, in accordance with some embodiments.

FIG. 3 depicts an example where a change made through the VFS is immediately evident and presented to the user without requiring the change being authorized by the cloud first in accordance with some embodiments.

FIG. 4 depicts an example where once all pending sync events are processed and reconciled with relevant staging entries, staging entries are synchronized up with the cloud in accordance with some embodiments.

FIG. 5(a)-(d) depict examples of updating file entries based on staging entries in accordance with some embodiments.

FIG. 6(a)-(b) depicts examples of fully and partially cached files, respectively, in accordance with some embodiments.

FIG. 7(a)-(b) depicts examples of caching of parts of a file based on caching policies in accordance with some embodiments in accordance with some embodiments.

FIG. 8 depicts a flowchart of an example of a process to support file synchronization and sharing with cloud storage in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support offline file system synchronization and sharing with cloud storage via a virtual file system (VFS) configured to provide a complete view of all files/file folders in a user's account. The VFS separates the storage of the files and their metadata into two primary databases—a staging database where local changes to the files are stored and a file database, which is a cloud-synchronized copy of path structure and metadata information of the files and file folders. The VFS allows the user to decide to store none, parts of, or the entirety of any file in the file system either locally or in the cloud so that the VFS is not subject to local storage capacities. The VFS first pulls/retrieves the latest version of a file to be modified from the cloud based on metadata in the file DB and updates the locally-stored version of the file based on the version retrieved from the cloud. Once the file is modified by the user locally via a client (even when the client is offline), the VFS commits and consolidates all the changes made by this and possibly other users to the file in the staging DB before synchronizing the changes to the cloud. Here, the VFS only synchronizes portions of the file that have been revised to the cloud to avoid duplication and only one copy of the file is maintained in the cloud at any time even when multiple users are editing the same file.

By separating the local changes to the files and their metadata via the staging DB and the cloud/remote file DB, respectively, the proposed VFS enables the user to make changes to any of its files using native applications running on the user's local machine even when the local machine is offline, wherein the changes are to be synced to the cloud later when the local machine is back online (connecting to the Internet). By consolidating the changes made to the file locally before synchronizing it to the cloud, the VFS keeps only one copy of the file and avoid storing multiple versions of the file in the cloud as some other products (e.g., Dropbox). In addition, by allowing the user to make changes to files accessed most frequently in the local staging DB without requiring authorization from the cloud first, the VFS achieves high efficiency with very low latency even when a large amount of local changes are being made.

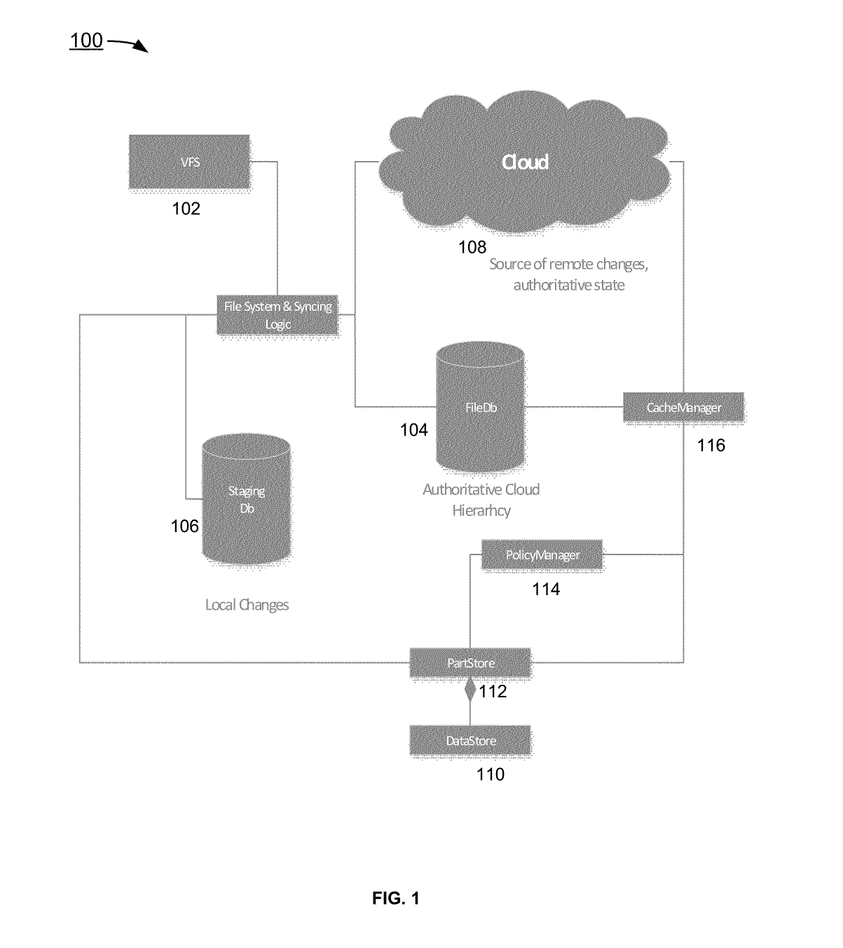

FIG. 1 depicts an example of a system diagram 100 to support file synchronization and sharing with cloud storage. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes one or more of virtual file system manager (VFS) 102, file database/DB 104, staging database/DB 106, cloud 108, data store 110, pat store 112, policy manager 114 and cache manager 116. These components of system 100 each resides and runs on one or more computing units. Here, each computing unit can be a computing device, a communication device, a storage device, or any electronic device capable of running a software component. For non-limiting examples, a computing device can be but is not limited to a laptop PC, a desktop PC, an iPod, an iPhone, an iPad, a Google's Android device, or a server/host/machine. A storage device can be but is not limited to a hard disk drive, a flash memory drive, or any portable storage device.

In the example of FIG. 1, The components of system 100 are configured to communicate with each other following certain communication protocols, such as TCP/IP protocol, over one or more communication networks. Here, the communication networks can be but are not limited to, Internet, intranet, wide area network (WAN), local area network (LAN), wireless network, Bluetooth, WiFi, and mobile communication network. The physical connections of the network and the communication protocols are well known to those of skill in the art. The forms of information being communicated among the various parties listed above over the communication networks includes but is not limited to, emails, messages, web pages with optionally embedded objects (e.g., links to approve or deny the request).

In the example of FIG. 1, the VFS 102 is configured to provide a complete view to a user to access files and folders in the user's account (file system), wherein locations of the files (either locally or in the cloud) are made transparent to the user. In some embodiments, each file in the VFS 102 includes one or more parts at appropriate offsets that together represent the complete file. Each part is a chunk of data that can be variable in size and represented by a unique identifying hash value (e.g., MD5-SHA1-SIZE) as its part key. Part store 112 is configured to store parts of the files and no two similar parts are redundantly stored in the part store 112 so that all files in the VFS 102 are de-duplicated. Every part in the part store 112 has a reference count, indicating how many users are accessing the part, and a part is removed from the part store 112 when its reference count goes to zero. Note that for parts written/modified by the user via the VFS 102 before the changes are flushed and a staging entry is created, in-memory references are created that prevent the parts from being cleaned up from the part store 112.

As shown in the example of FIG. 1, file DB 104 is a database that fully describes and maintains state/metadata of the file/folder structure in the user's account. It is the authoritative copy of the file/folder structure in the cloud. Each entry in the file DB 104 is a row associated with a list of part keys representing all parts in a file/file folder in the VFS 102. Staging DB 106 is a database that describes and stores all local changes made to the files in the file system from the reference point of the file DB 104. Each entry in the staging DB 106 is a row associated with a list of part keys, representing local changes to the parts in a file in the VFS 102. Cloud 108 in FIG. 1 includes a plurality of servers configured to manage and store the files for the user at geographically distributed locations.

In some embodiments, where the local file DB 104 is in sync with the cloud 108, i.e., the local file DB 104 accurately reflects the current state of the files in the cloud, and there are no pending local changes in the staging DB 106, the VFS 102 is configured to present the user with folders and files corresponding to the file entries in the file DB 104. In some embodiments, each file entry contains a slash (“/”) delimited path to a file, wherein each component of the path (except for the last one) represents a parent folder, and the last (leaf) component represents the file itself.

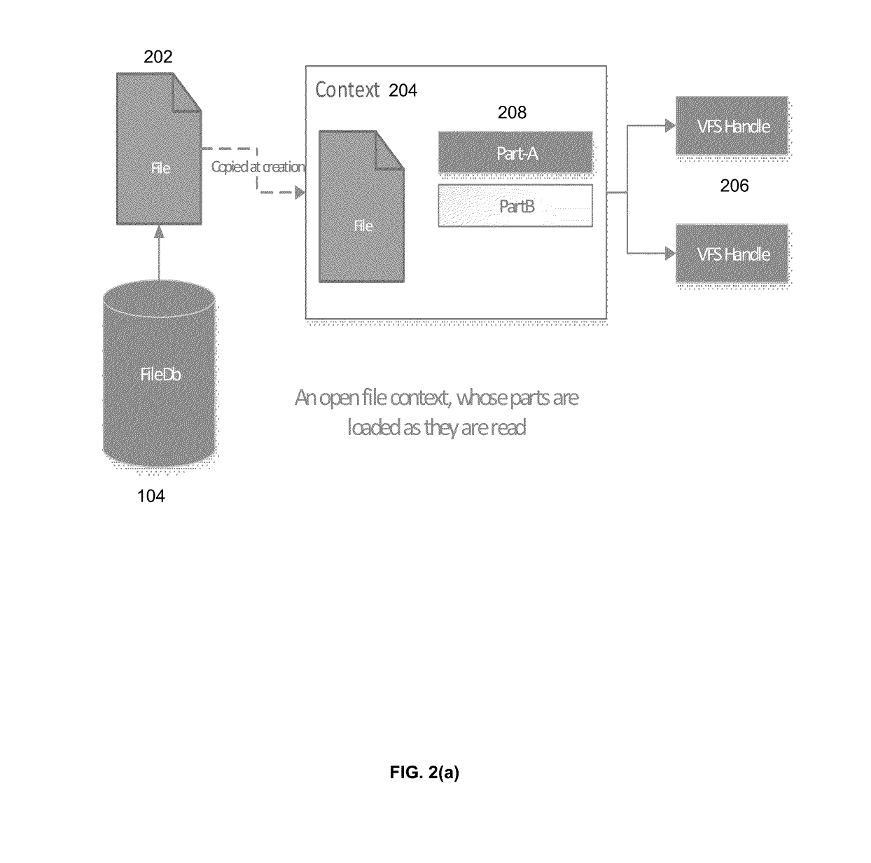

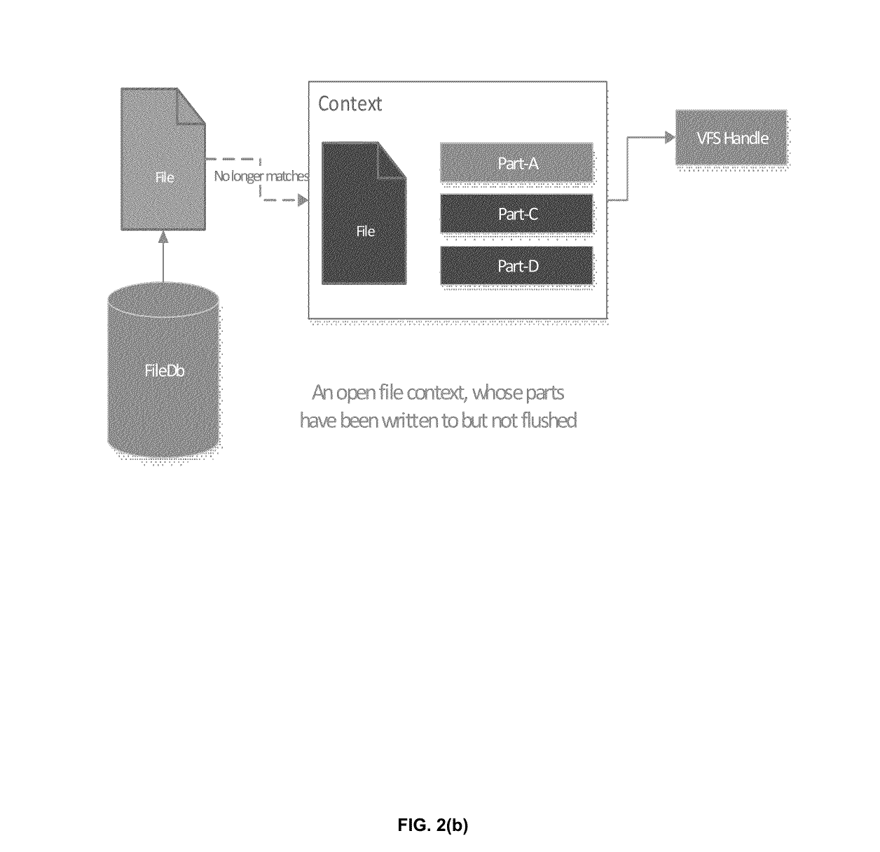

In some embodiments, when the user opens a file 202 to read through the VFS 102, the VFS 102 is configured to load a list of part keys associated with the entry of the file 202 in the file DB 104 into memory and to create a context 204 associated with the file 202 as shown in the example of FIG. 2(a). A VFS file handle 206, which is a unique numeric identifier among all open files, is then created for the file 202 and returned to the VFS 102. Further operations to the opened file 202, such as reads and writes, will include the numeric VFS handle 206 of the file 202 so that the appropriate context 204 can be looked up. If the same file 202 is opened again at the same time, for a non-limiting example, by another user via another application, it is assigned its own file handle 206_2, but the same context 204 is used. Closing the file destroys the VFS handle 206, and when the last handle for the file 202 goes away, so too does its context 204.

When the user attempts to read a file 202 that has been opened, the list of part keys in the associated context 204 is referenced. Based on the offset and size of the read, the necessary parts for the file 202 can be determined. If the parts 208s already exist locally, they are read from disk (or in-memory LRU cache) of the local machine and the data for the read operation is returned to the user. Otherwise, the parts are downloaded directly from the cloud 108 and stored on disk for future access.

In some embodiments, a user with a high quality network connection to the cloud 108 may experience seamless access to all files in the user's account in the cloud. With a moderate connection, the user may experience a slightly delay when first opening a file, and a poor-quality connection may result in degraded performance when the user tries to access files whose parts are not already available locally. However, this situation can be alleviated by the proactive caching scheme discussed below.

In some embodiments, when the user attempts to write to a file 202 that has been opened, the list of part keys in the associated context 204 is also referenced as shown in the example of FIG. 2(b). If the offset and size of the write span only a portion of any given part, the part is either loaded from disk or downloaded from the cloud 108 similar to when a read operation is performed. If the write would span the entire length of a part, a blank piece of data is allocated for the part instead. If the write would extend beyond the last existing part, that part is extended up to a specific size. If it would extend even further, a new blank part is allocated to make up the remainder up to the specific size. As such, multiple blank parts may be needed for the write operation.

In some embodiments, the maximum size of every part in a file 202 is the same (e.g., 1 MB) by convention. In some embodiments, however, a larger part size is chosen (e.g., 5 MB), wherein such choice is only made if the file is known to be of large size before any data is written to it since combining the parts and rehashing them all when the file grows too large would be cumbersome and slow. When a “truncate” operation is performed by the VFS 102 through the underlying operating system, it immediately sets the size of the file to a given offset and fills in the gap (if growing rather than shrinking) with zeroes. If the file only had zero or one part to begin with, a larger size can be safely chosen. Notably, when the VFS 102 makes a copy of a file through an operating system, it will often immediately perform a truncate operation to grow the copy to the size of the original before writing any data.

Once the parts 208s are loaded (or created) into the memory, the VFS 102 spreads the data to be written across them. The parts 208s are then re-hashed and assigned new part keys. These new parts (Part_C and Part-D in FIG. 2b) are written to the disk, and the list of part keys in the context 204 is updated with the new ones. At this point, the copy of the file 202 in the context no longer matches with the original copy of the file 202 in the cloud. When the user performs a flush operation or when a specific amount of data (e.g., 50 MB) has been written to the context, whichever comes first, the VFS 102 commits a list of keys of the modified parts to the staging DB 106.

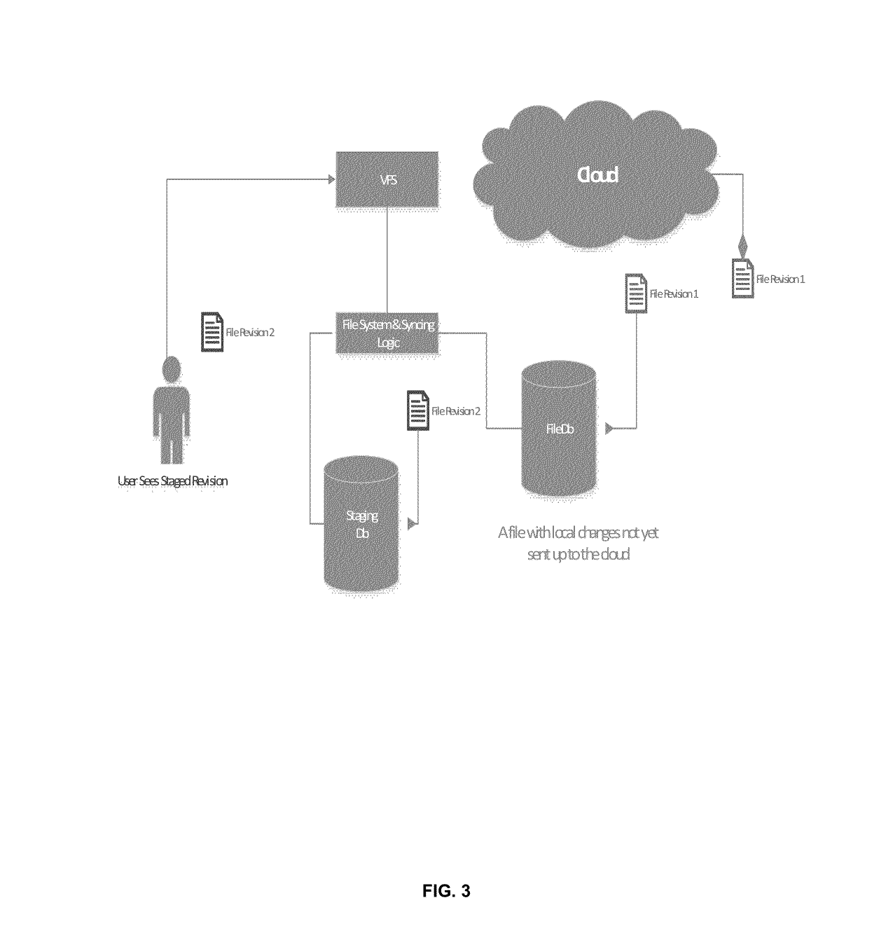

When a user makes a change to the file 202 via the VFS 102, a staging entry is created and stored in the staging DB 106 that represents this change. Note that the staging entries depend on the file entries they modify. A set of changes makes no sense without their origin states, while the file DB 104 can stand on its own and be used to present a coherent view in the VFS 102. When the user attempts to view the file 202 through the VFS 102, whether it be the contents of the file 202 or the children of a file folder, the staging entries associated with that file (or its children) are taken into account and are used to form a cohesive current state of the file. As such, a change made through the VFS 102 is immediately evident and presented to the user without requiring the change being authorized by the cloud 108 first as shown by the example in FIG. 3.

In some embodiments, there are at least four types of staging entries, which correspond to the four basic operations to the file/file folder listed below when the staging DB 106 synchronizes with the cloud 108. Here, the staging entries are converted directly into a plurality of change events that are sent up to the cloud, wherein each change event is an event originated locally that describes changes need to be synchronized up to the cloud 108.
Add: a file or folder which did not previously exist is added to the cloud. The entry includes one or more of: the path to the file or folder in the file system, whether the object is a file or a folder, the total size of the file (always zero for folders), a timestamp of when the local change occurred, and a list of part keys and their associated offsets within the file (not applicable to folders).
Modify: a file is having its contents modified. The entry includes one or more of: a reference to the associated file entry, the total size of the file, a timestamp of when the local change occurred, and a list of part keys and their associated offsets within the file.
Rename: a file or folder is being renamed and/or moved. The entry includes one or more of: a reference to the associated file entry, the target path to which it will be renamed to, a timestamp of when the local change occurred, and a list of part keys and their associated offsets within the file. This operation is only applicable with a file has been both renamed and modified.
Remove: a file or folder is being deleted. The entry includes one or more of: a reference to the associated file entry and a timestamp of when the local change occurred.

In some cases, a local change to a file made through the VFS 102 simply results in the creating of a staging entry describing that change as detailed above. In some cases, however, there are existing staging entries that have not been synced up to the cloud 108, which might be interfered with. For a non-limiting example, a Modify operation on a file that already has a Modify in the staging entry. A core tenet of the system 100 is that, at all times, there exactly zero or one staging entry that modifies any given file entry in the file DB 104 and every operation on the VFS 102 maintains this rule. Similarly, exactly zero or one Add or Rename may exist at a given path, and any given path must resolve to exactly zero or one pair of file and staging entries (the file half of the pair may be absent in the case of an Add, and the staging half may be absent if the object has not been modified). If an existing staging entry would interfere with the one about to be created, the original staging entry gets replaced by the VFS 102. Modification and replacement of other staging entries may result as well. For non-limiting examples:
If the user modifies a file that only exists locally (and is thus represented by an Add or “local-only”), the original Add is removed and replaced by a new one with the appropriately modified list of part keys.
If the user renames a local-only file or folder, the original Add is replaced by an identical one with a different path.
If the user modifies a renamed file (or renames a modified file), the original Add or Rename is replaced by a Rename that has a list of part keys. This Rename-combo represents both changes.
If the user removes a file or folder that has any other kind of staging entry, that entry is removed. If it was an Add, then nothing else happens. Otherwise a Remove is created.
If the user renames a file or folder back to its original path, the existing Rename is simply deleted.
If the user modifies a file, then modifies it again such that it now contains the same data it did before, then the existing Modify is simply deleted.

In some cases, native applications running on local machines may save their files by writing to temporary files that are renamed, rather than writing directly over the original. As such, the VFS 102 adopts several optimization attempts to eliminate Removes wherever possible to allow the cloud 108 to maintain a coherent version history. For non-limiting examples,
If the user creates a new file or folder at a path that has a Remove on it, the Remove is deleted. For a file, a Modify is created; for a folder, nothing else is needed.
If the user renames a local-only file to a path that has a Remove on it, both the Add and the Remove are deleted and replaced by a Modify at the target path, using the list of part keys the Add.
If the user removes a file that has been renamed to a path in the same directory, and an Add exists at its original path, then both the Add and Rename are deleted and replaced by a Modify at the original path, using the list of part keys of the Add.

Once a change has been made to a file at a particular path via the VFS 102, the VFS 102 is configured to resolve discrepancies between the entry of the file in the file DB 104 and (if applicable) the entry in the staging DB 106 that modifies the file when the user attempts to access the file/folder. Specifically, the VFS 102 is configured to:
1. Search for a staging entry with the exact path. Note that only Add and Rename operation have a path entry, and if a staging entry with matching path is found, then it is guaranteed to be the correct one. Add operations do not have an associated file entry, so they can fully describe the file themselves. Rename operations have a reference to the exact file entry they modify. If the Rename also has a list of part keys, then those are used as the contents of the file. Otherwise, the list of part keys for the file entry is used.
2. If there is no exact match, the VFS 102 is configured to search for a Rename at a parent path. If a folder has been renamed to be a parent of the path, then the VFS 102 swaps out a corresponding portion of the path and searches for a file entry with this exact swapped path. For a non-limiting example, if the VFS 102 attempts to resolve /A/B/C, and a Rename of /D→/A is found, then the VFS 102 searches for /D/B/C. If the file entry exists, then it is the correct one for the path (otherwise, no object exists here). The VFS 102 then searches for an associated Modify. If a Modify exists, its list of part keys is used for the content of the file. Otherwise, the file entry's list is used.
3. If there is no renamed parent path, the VFS 102 searches for a file entry with the exact path. If the file entry exists, then it is the correct one for the path and the VFS 102 searches for an associated Modify. If a Modify exists, its list of part keys is used for the contents of the file.

When listing the contents of a folder, several more steps in addition to those above are required to find its children. Specifically, the VFS 102 is further configured to:
4. Search for direct children of the file entry found in Steps 1-3 above. For each such child, the VFS 102 searches for associated staging entries. If any child has a Remove or Rename, it is skipped (If a direct child was renamed to still be within this directory, it will be found in the next step). The remainder are added to the list of children to be returned.
5. Search for staging entries that Add or Rename objects to be direct children of this path. The VFS 102 also finds the file entries associated with any Renames and all these children to those from the previous step.

In some embodiments, the VFS 102 is configured to synchronize the file DB 104 with the cloud 108 by processing a series of events sent by the cloud 108. Here, an event is a package of metadata describing a change being synchronized between the cloud 108 and a client, which is a software program running on the user's local machine/computing device that synchronizes with the cloud 108 and provides access to the files via the VFS 102. Whenever a third party (such as an application web interface or another client with access to the same files) makes a modification to the file/folder structure stored in the cloud 108, the cloud 108 notifies all other clients that a change has occurred. The client then downloads the changes in the form of a series of events that describes the change(s). By “playing back”/synchronize these events in the order that they occurred in the cloud 108, the VFS 102 can guarantee that the file DB 104 contains the same up-to-date information of the file system as is in the cloud 108.

In some embodiments, each of the events has an associated identifier called watermark, which is a numerical identifier assigned to each individual event that increments by one for each successive event. When the VFS 102 requests new events from the cloud 108, that request will contain the watermark of the last event processed by the VFS 102. This way, the cloud 108 knows to send back only those events with watermarks greater than the one in the request.

As in the case with staging entries, there are four basic types of events for updating the entries of the file DB 104: Add, Modify, Rename, and Remove. In addition to its type, each event includes whatever other information necessary to perform the associated operation.
Add: a file or folder that did not previously exist is being added. The event includes one or more of: the path to the file or folder in the user's folder structure, whether the object is a file or a folder, the total size of the file (always zero for folders), a timestamp of when the remove change occurred in the cloud, and a list of part keys and their associated offsets within the file (not applicable to folders).
Modify: a file is having its contents modified. The event includes one or more of: the path to the file in the account's folder structure, the total size of the file, a timestamp of when the remove change occurred in the cloud, and a list of part keys and their associated offsets within the file.
Rename: a file or folder is being renamed and/or moved. The event includes one or more of: the path to the file or folder in the user's folder structure, the target path to which it will be renamed to, and a timestamp of when the remove change occurred in the cloud.
Remove: a file or folder is being deleted. The event includes one or more of: the path to the file or folder in the user's folder structure, and a timestamp of when the remove change occurred in the cloud 108.

Since staging entries depend closely on the state of the file DB 104 at their creation, modifications to the file DB 104 via processing of synchronized (or sync) events could invalidate them where each sync event is originated in the cloud 108 and describes changes that need to be synced down to the file DB 104. As such, the VFS 102 is configured to update any such otherwise-invalidated staging entries so that they still produce the intended effect. For non-limiting examples:
If an Add sync event is received at a path where an Add staging entry exists, and
   If both are for files and the parts are different, then the staging entry is converted into a Modify with the same parts. If the staging entry's timestamp is earlier than the sync event's, the Modify is be flagged as “out-of-band”.
   If both are for folders, or both are for files and the parts are the same, then the staging entry is deleted.
   If they are for different types of objects, then the staging entry gets “conflict-renamed”, which means its name gets tweaked slightly, e.g., having “(1)” or “(2)” placed just before its extension, to make it obvious to the user that a conflict occurred.
If a Modify sync event is received for a file that has a Modify or Rename-combo staging entry, and
   If the file has a Modify with the same parts, then it is deleted.
   If the file has a Rename-combo with the same parts, then it has its list of part keys removed.
   If the file has a Modify with different parts and an earlier timestamp, then the Modify is flagged as out-of-band (If the sync event's timestamp is the earlier one, no change is made).
   If the file has a Rename-combo with different parts and an earlier timestamp, then the Rename has its list of part keys transferred to a brand new out-of-band Modify (if the sync event's timestamp is the earlier one, no change is made).
If a Rename sync event is received for a folder, all Add and Rename staging entries whose paths are children of the folder being renamed must have their paths modified to reflect the change.
If a Remove sync event is received for a folder or file and there are staging entries exist at the same path or for children paths,
   If it's a file which has a Modify (or Rename-combo) staging entry, the existing staging entry is replaced with an Add at the original path (or the Rename target).
   If it's a folder, there could be local changes to its children that must be preserved, so a migration must occur. The migration logic will find all files with a Modify or Rename staging entry that would be recursively affected by the Remove sync event. Files that originate as children of the path being removed and have Modify (or Rename-combo) are replaced by an Add at their current location (which might be outside the path being removed). Adds of folders leading up to them may need to be created. Files that originate outside the path being removed but have a Rename (whether pure or combo) placing them inside it retain their staging entries. However, Adds of folders leading up to their target path may need to be created.

In some embodiments, an out-of-band Modify staging entry represents the content of a file whose local changes were trampled by newer changes downloaded/retrieved from the cloud 108 before the local content could be sent up to the cloud 108. The file no longer has any effect on how files and folders are represented on the VFS 102, and when finally sent to the cloud 108, it will be inserted as the second-to-most-recent revision in the file's history so that it can still be accessed.

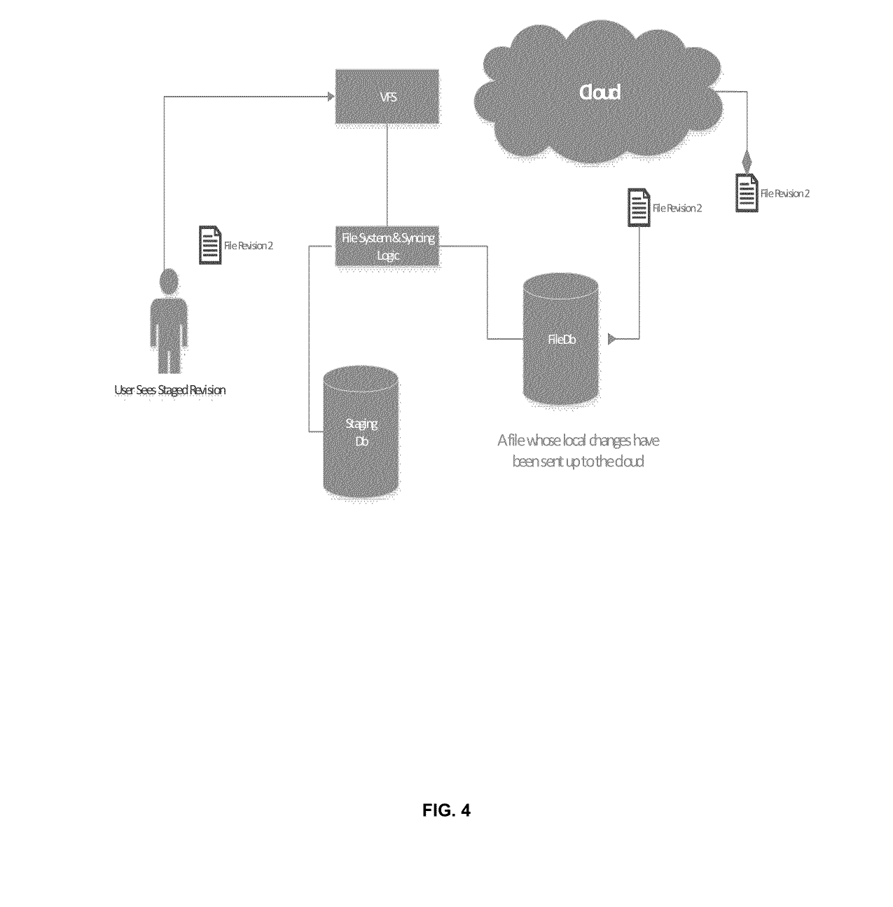

A shown in FIG. 4, once all pending sync events (if any) are processed and reconciled with relevant staging entries, the VFS 102 can start the process of syncing staging entries (in the form of change events having the same components as their corresponding sync events) up with the cloud 108 in three phases described below. If staging entries are created during processing of Phase 2 or 3 that belong to an earlier phase, then the process must start over at that earlier phase.
Phase 1: Modifies (or the Modify portions of Rename-combos) of files are synchronized to the cloud 108. These events have no dependencies on others and can be sent up incrementally.
Phase 2: Metadata-only events (Renames, Removes, and Adds of folders, all of which contain no part data) are synchronized to the cloud 108. These events may have many complex interdependencies and the order the events are processed in does matter.
Phase 3: Adds of files are synchronized to the cloud 108. These events have no dependencies on others and they can be sent up incrementally, wherein the order the events are processed in doesn't matter.

In some embodiments, a number of staging entries are chosen (in roughly the order they were created) in Phases 1 and 3 that do not exceed configurable limits of total number of parts or total number of files. These parts are all sent up to the cloud 108 (if the cloud 108 does not already have them), and then change events corresponding to each of the chosen staging entries are sent up. If they are accepted by the cloud 108, the changes are applied to the file DB 104 and removed from the staging DB 106.

Staging entries in Phase 2 is more complicated. An arbitrary subset of Phase 2 events cannot be sent up with any guarantee of safety or correctness because the execution of one might depend on one or more of the others. For a non-limiting example, renaming a file to inside some folder may depend on the creation of that folder to begin with. In some embodiments, rather than algorithmically creating a safe ordering (or prove the safety of an arbitrary or heuristically-generated one), the VFS 102 performs a work-around involving temporary renames as described below:
First, change events for every metadata-only staging entry are put into a tree structure based on what they modify, wherein Rename events are placed at the destination path, but the tree node at the source path also gets a special entry placed there. This tree is then used to find events with potential interdependency problems.
The tree is then iterated breadth-first to find events that must come first before others that might depend on them. All Removes fall into this category of “dependency” events, as do Renames in which some other event can be found at a parent node (direct or indirect). The special entry placed at the source of Renames on the tree is there to be found by actual Rename events located at child nodes.
When a Rename is determined to be a dependency, it is split into two separate Renames. The first one has the true source path and a fake, intermediate target path. The second has the true target path and that same intermediate path as the source. The first is put at the front of the list of events to send to the cloud 108 (along with all Removes), while the second is placed among the remaining events.

As a result, there are two groups of events sent to the cloud 108 all at once—the first removes/renames things out of the way, and the remainder puts things into place:
Removes, first half of dependency Renames to intermediate paths. These are in REVERSE breadth-first order.
Adds, second half of dependency Renames, and other Renames. These are in FORWARD breadth-first order.

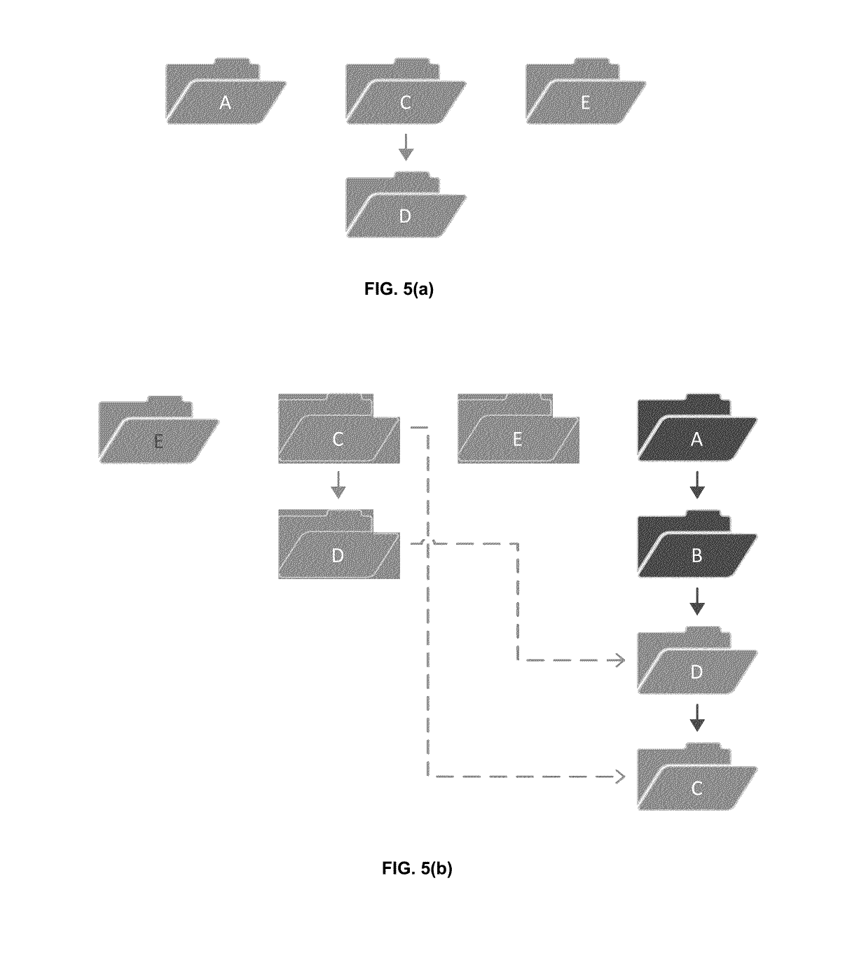

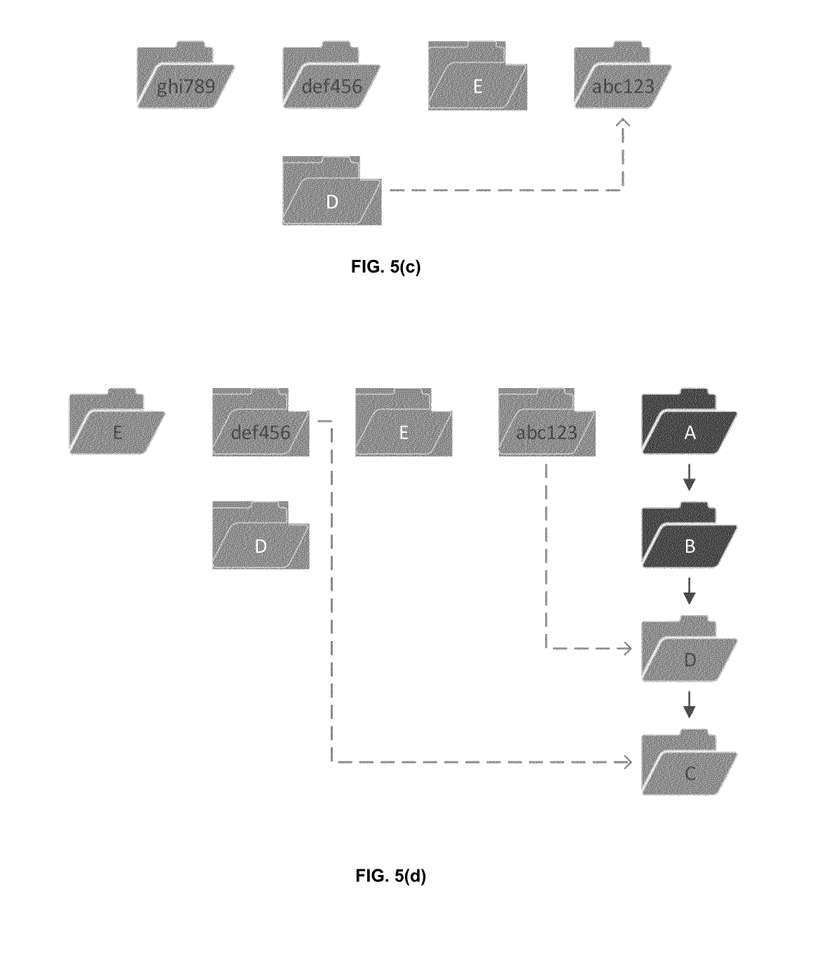

For a non-limiting example, the file entries as shown in FIG. 5(a) include /A, /C, /C/D, and /E. The staging entries that have been made include REMOVE /E, RENAME /A→/E, ADD /A, ADD /A/B, RENAME /C/D→/A/B/D, and RENAME /C→/A/B/D/C, where the objects C and D are swapping their parent-child relationship as shown in FIG. 5(b). The corresponding change events would then be created in the following order as shown in FIG. 5(c): RENAME /C/D→/abc123, REMOVE /E, RENAME /C→/def456, and RENAME /A→/ghi789. The first set are the dependency events, where things are renamed out of the way or removed. Then things are built back up via the following events as shown in FIG. 5(d): ADD /A, RENAME /ghi789→/E, ADD /A/B, RENAME /abc123→/A/B/D, and RENAME /def456→/A/B/D/C. Since all these events are sent to the cloud 108 at the same time, users will never actually experience the temporary paths because doubly-renamed objects get normalized out by the cloud 108.

As described above, there can only be a single staging entry modifying a file or folder at any given time. There is a potential conflict here in that a staging entry which has been used to create a change event to send up to the cloud 108 needs to stick around so that it can be applied to the file DB 104 when the cloud 108 authorizes the change. At the same time, however, the user should still be able to further modify that file or folder.

In some embodiments, the VFS 102 solves the problem by flagging a staging entry as “pending” when it is used to create a change event. If further local modifications are made before the cloud 108 has replied with authorization of the change, the staging entry is flagged as “pending-replaced” and no longer has any effect on how files and folders are represented via the VFS 102. A brand new staging entry is created that reflects the new change being made by the user.

Upon authorization of a change by the cloud 108, the original staging entry has its change applied to the file DB 104 and is deleted. Then, if the staging entry happened to be flagged as pending-replaced, the new staging entry that replaced it may need modification. For non-limiting examples:
If an Add was replaced by another Add, the newer Add must be converted into a Modify with the same parts.
If an Add is flagged as pending-replaced but no newer Add exists at its path, a search for an Add with the same “inode” must commence, wherein an inode is a unique file identifier that is retained when an object is renamed. Even when a local-only object is authorized to replace its Add by a file entry, that file entry inherits the original inode. If an Add with that inode is found, then the local-only object must have been renamed, so a Rename is created to reflect this. If no such Add is found, then it must have been deleted, so a Remove is created to reflect this.
If a Modify is replaced by a Rename and the Rename has the exact same parts, then the parts are stripped off the Modify.
If a pure Rename is replaced by a Rename-combo with the same path, then the Rename-combo is deleted and a Modify with the same parts is created.

As detailed above, when a user reads a file via the VFS 102, performance can be greatly enhanced if the parts for that file are already available locally. In some embodiments, the file entries in the file DB 104 can be in one of two states—cached or un-cached. Cached state means that all parts for the file are locally stored in data store 110 and part store 112 in FIG. 1 and are available via the VFS 102. Here, the data store 110 is key value disk storage system whereby part keys referencing parts stored in the part store 112 on the disk. If the parts in cached state are opened, the latency for fetching the parts is very low, similar to that of a file existing on a normal file system. In un-cached state, not all parts of the file are locally stored in the data store 110 and are available via the VFS 102. If the parts in un-cached state are opened, the latency for fetching the parts may be very high, similar to that of a network file system.

In some embodiments, a file entry being considered for caching results in incrementing the reference counts of all its parts in the part store 112 by 1. In addition, the mere existence of a Add, Modify or Rename-combo operation in the staging DB 106 causes its associated parts' reference counts to be incremented. On the flip side, the removal (or un-caching) of any of these file or staging entries will decrement the reference counts of their parts.

In some embodiments, the VFS 102 is configured to cache a file according to its caching priority/policy, which is based on, for non-limiting examples, how recently the file was accessed or modified, whether the file is currently open by the user, or if the user has flagged the file as Pinned, meaning that the file has been requested to be permanently cached on the system. In some embodiments, cached files are prioritized based on their current states. If a file is opened for modification to the staging DB 106, the file caching priority is high. If the file is not open, but has been modified or accessed recently and whose size can fit in the allotted storage amount specified in the policy, its priority is low. If the file is not open, is not pinned, or cannot fit in the allotted storage amount specified in the policy, its priority is zero and it will not be cached.

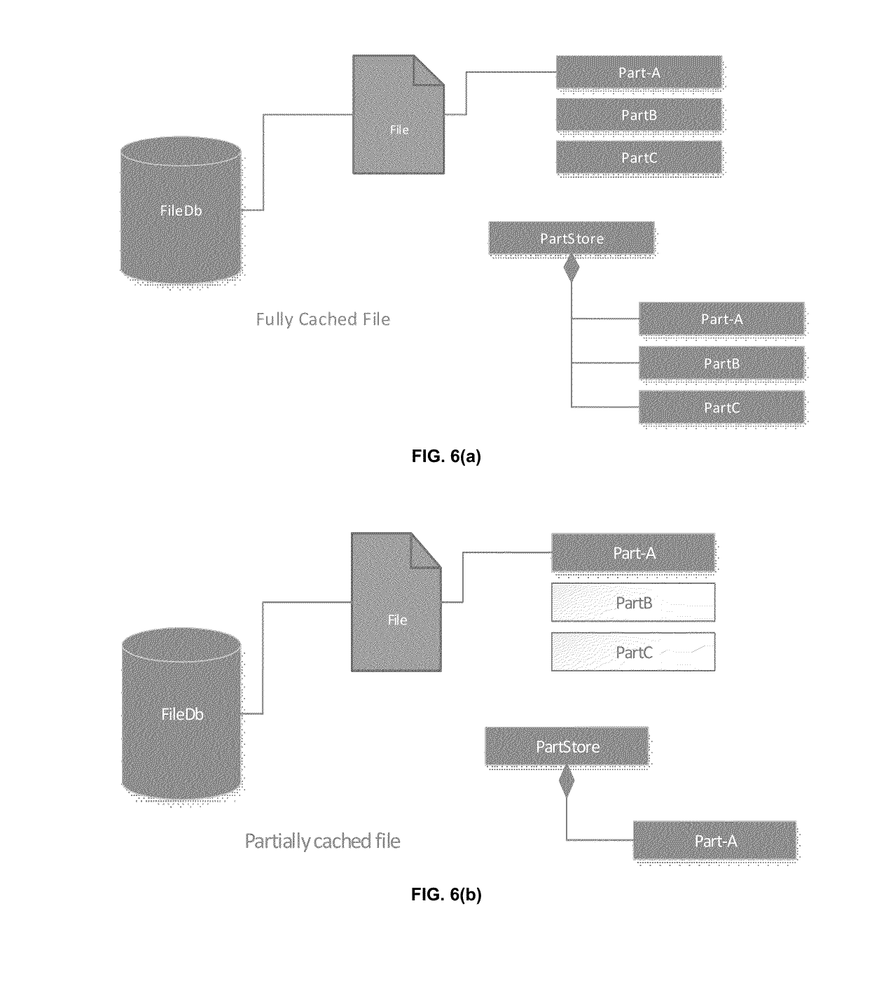

In some embodiments, a file may be partially or fully cached as shown by examples in FIGS. 6(a) and 6(b), respectively. The knowledge of the list of parts being cached is always keeps up to date in the system. Anytime a change is detected in the cloud 108, a new part list is downloaded and previous parts which may have been downloaded are unmarked. The VFS 102 then deletes the unmarked parts when the part reference count goes to zero.

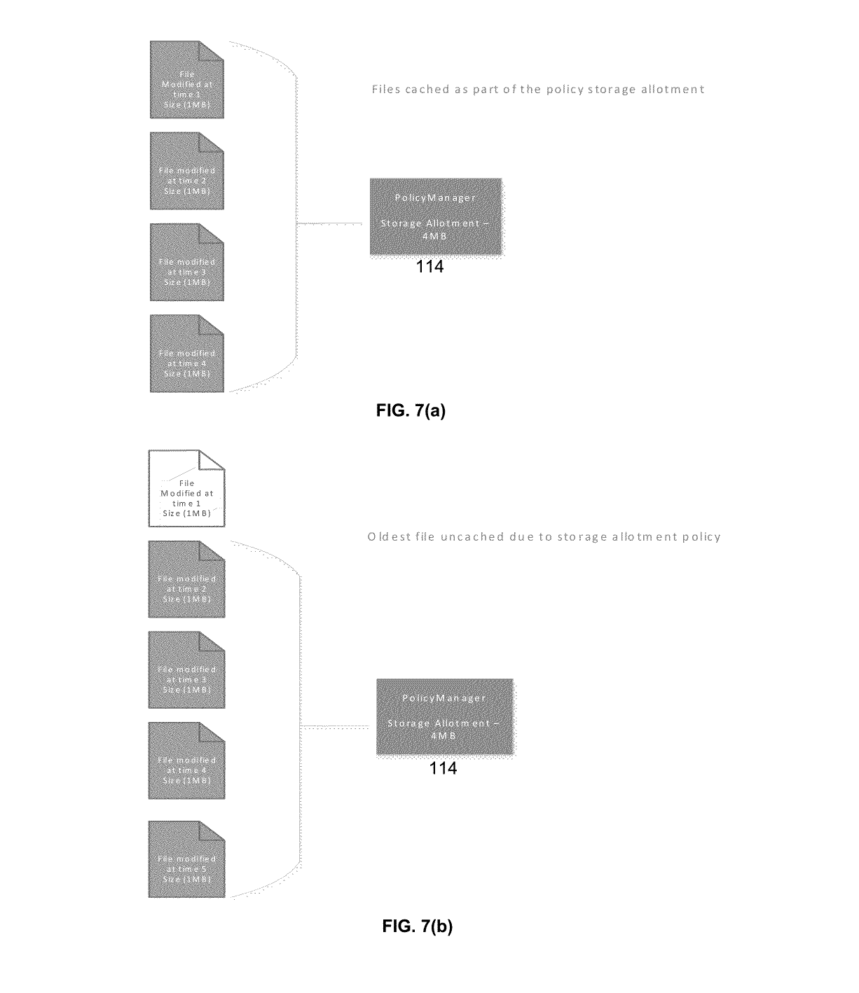

In the example as shown in FIG. 1, policy manager 114 is configured to determine the overall caching policy (e.g., what files should be cached and in what order) and store the requested high watermark of storage allotted to the local machine. In some embodiments, files in the user's account may be passively cached by cache manager 116 as the storage allotment allows based on the access or modify time of the file. Anytime a new file enters the file system, its time information is recorded as part of its metadata. If the system storage allotment (e.g., 10 GB) is larger than the most frequently used portion of the file, the file will always be cached by the cache manager 116 according to the policies in the policy manager 114 as shown by the example in FIG. 7(a). Any new file which gets modified will be placed at the top of the list for caching by the policy manager 114, and anything which has not least modified will be un-cached according to storage allotment policy of the policy manager 114 as shown in FIG. 7(b), where the oldest modified file will be un-cached, and the newly modified file will be cached.

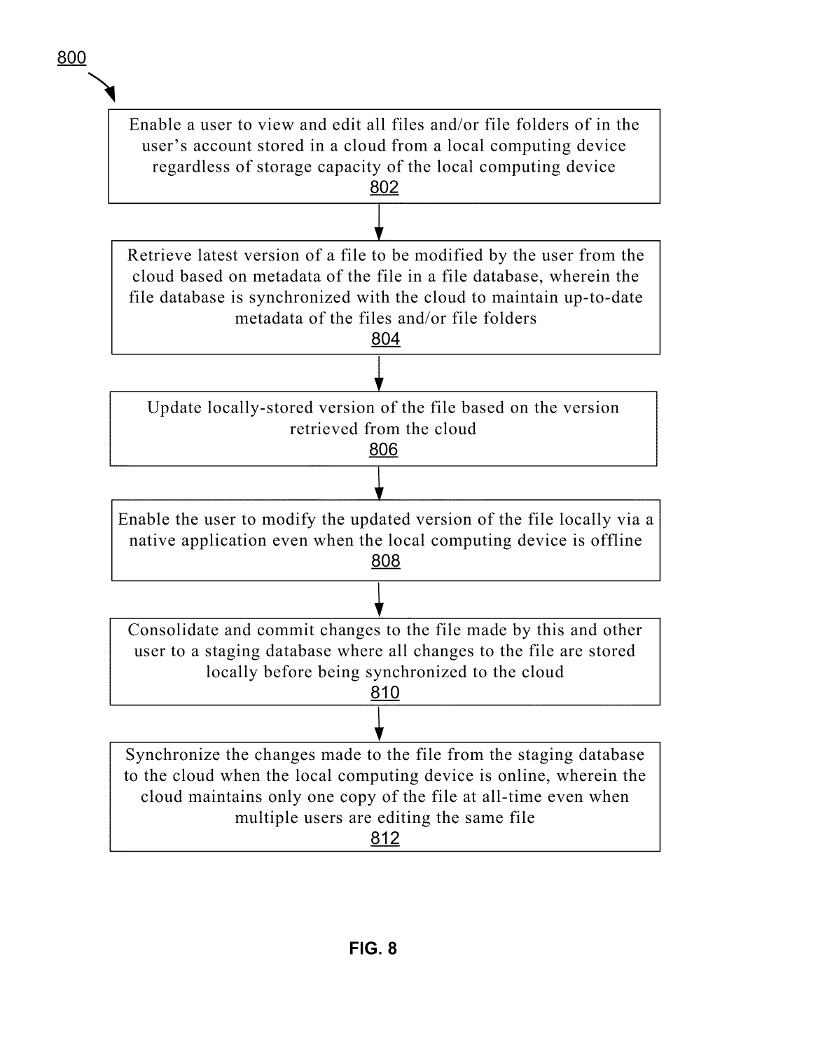

FIG. 8 depicts a flowchart 800 of an example of a process to support file system synchronization and sharing with cloud storage. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 8, the flowchart 800 starts at block 802, where a user is enabled to view and edit all files and/or file folders in the user's account stored in a cloud from a local computing device regardless of storage capacity of the local computing device. The flowchart 800 continues to block 804, where latest version of a file to be modified is retrieved from cloud based on metadata of the file in a file database, is synchronized with the cloud to maintains up-to-date metadata of the files and/or file folders. The flowchart 800 continues to block 806, where locally-stored version of the file is updated based on the version retrieved from the cloud. The flowchart 800 continues to block 808 where the user is enabled to modify the updated version of the file locally even when the local computing device is offline. The flowchart 800 continues to block 810 where changes made to the file by this and possibly other user are consolidated and committed to a staging database where all changes are stored locally before being synchronized to the cloud. The flowchart 800 ends at block 812 where the changes made to the file are synchronized from the staging database to the cloud when the local computing device is online, wherein the cloud maintains only one copy of the file at all-time even when multiple users are editing the same file.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support file system synchronization and sharing with cloud storage, comprising:
a virtual file system manager (VFS) configured to
enable a user to view and edit all files and/or file folders in the user's account stored in a cloud from a local computing device regardless of storage capacity of the local computing device;
retrieve latest version of a file to be modified by the user from the cloud based on metadata of the file in a file database;
update locally-stored version of the file based on the version retrieved from the cloud;
enable the user to modify the updated version of the file locally via a native application even when the local computing device is offline;
consolidate and commit changes to the file made by this and other user to a staging database;
synchronize the changes made to the file from the staging database to the cloud when the local computing device is online, wherein the cloud maintains only one copy of the file at all-time even when multiple users are editing the same file;
said file database synchronized with the cloud to maintain up-to-date metadata of the files and/or file folders;
said staging database where all changes to the file are stored locally before being synchronized to the cloud.

2. The system of claim 1, wherein:
the cloud includes a plurality of servers configured to manage and store the files for the user at geographically distributed locations.

3. The system of claim 1, wherein:
the VFS is configured to synchronize only portions of the file that have been revised to the cloud to avoid de-duplication.

4. The system of claim 1, wherein:
the VFS is configured to enable the user to make changes to the file to the local staging database without requiring authorization from the cloud first.

5. The system of claim 1, wherein:
the file includes one or more parts at appropriate offsets that together represent the complete file, wherein each part is a chunk of data that can be variable in size and represented by a unique identifying hash value as its part key.

6. The system of claim 5, further comprising:
a part store configured to store the parts of the file wherein no two similar parts are redundantly stored in the part store and every part in the part store has a reference count.

7. The system of claim 6, wherein:
the VFS is configured to create a context and load a list of parts into the context of the file when the user opens the file through the VFS based on their keys associated with an entry of the file in the file database.

8. The system of claim 7, wherein:
the VFS is configured to download and store a part of the file directly from the cloud if the part is not already stored on disk of the local computing device.

9. The system of claim 7, wherein:
the VFS is configured to update the keys of the parts that have been modified by the user and commit a list of the keys of the modified parts to the staging database.

10. The system of claim 1, wherein:
the VFS is configured to make the changes made to the file immediately available to the user without requiring the change being authorized by the cloud first.

11. The system of claim 1, wherein:
the VFS is configured to
enable the user to perform one or more of a plurality of operations for the changes to the file;
create corresponding entries of the operations in the staging database;
convert the entries to a plurality of change events, which are originated locally that describe the changes need to be synchronized up to the cloud.

12. The system of claim 11, wherein:
the VFS is configured to resolve conflict between and a newly created entry in the staging database that would interfere with an existing entry to maintain that there is only zero or one single entry in the staging database that modifies any entry in the file database.

13. The system of claim 11, wherein:
the VFS is configured to resolve discrepancies between an entry of the file in file database and the entry in the staging database that modifies the file once the changes have been made to the file.

14. The system of claim 1, wherein:
the VFS is configured to synchronize the file database with the cloud by requesting, downloading and processing a series of events sent by the cloud, wherein each of the events is a package of metadata describing a change to be synchronized with the cloud.

15. The system of claim 1, wherein:
the VFS is configured to send to the cloud and insert the local changes to the file as the second-to-most-recent revision in history of the file when the local changes are trampled by newer changes downloaded from the cloud before the local changes could be synchronized to the cloud.

16. The system of claim 6, wherein:
the VFS is configured to cache none, some, or all parts of the file locally in the part store for access and editing by the user, wherein reference counts of the parts are updated based on an operation on an operation performed on the file by the user.

17. The system of claim 1, wherein:
the VFS is configured to cache the file according to its caching policy, which is based on one or more of: how recently the file was accessed or modified, whether the file is currently open by the user, or if the user has flagged the file as having been requested to be permanently cached.

18. The system of claim 1, wherein:
the VFS is configured to cache the file passively as storage allotment of the local computing device allows based on access or modify time of the file.

19. A computer-implemented method to support file system synchronization and sharing with cloud storage, comprising:
enabling a user to view and edit all files and/or file folders of in the user's account stored in a cloud from a local computing device regardless of storage capacity of the local computing device;
retrieving latest version of a file to be modified by the user from the cloud based on metadata of the file in a file database, wherein the file database is synchronized with the cloud to maintain up-to-date metadata of the files and/or file folders;
updating locally-stored version of the file based on the version retrieved from the cloud;
enabling the user to modify the updated version of the file locally via a native application even when the local computing device is offline;
consolidating and committing changes to the file made by this and other user to a staging database where all changes to the file are stored locally before being synchronized to the cloud;
synchronizing the changes made to the file from the staging database to the cloud when the local computing device is online, wherein the cloud maintains only one copy of the file at all-time even when multiple users are editing the same file.

20. The method of claim 19, further comprising:
synchronizing only portions of the file that have been revised to the cloud to avoid de-duplication.

21. The method of claim 19, further comprising:
enabling the user to make changes to the file to the local staging database without requiring authorization from the cloud first.

22. The method of claim 19, wherein:
the file includes one or more parts at appropriate offsets that together represent the complete file, wherein each part is a chunk of data that can be variable in size and represented by a unique identifying hash value as its part key.

23. The method of claim 22, further comprising:
storing the parts of the file wherein no two similar parts are redundantly stored and every part in the part store has a reference count.

24. The method of claim 23, further comprising:
creating a context and loading a list of the parts into the context of the file when the user opens the file based on their keys associated with an entry of the file in the file database.

25. The method of claim 24, further comprising:
downloading and storing a part of the file directly from the cloud if the part is not already stored on disk of the local computing device.

26. The method of claim 24, further comprising:
updating the keys of the parts that have been modified by the user and committing a list of the keys of the modified parts to the staging database.

27. The method of claim 19, further comprising:
making the changes made to the file immediately available to the user without requiring the change being authorized by the cloud first.

28. The method of claim 19, further comprising:
enabling the user to perform one or more of a plurality of operations for the changes to the file;
creating corresponding entries of the operations in the staging database;
converting the entries to a plurality of change events, which are originated locally that describe the changes need to be synchronized up to the cloud.

29. The method of claim 28, further comprising:
resolving conflict between and a newly created entry in the staging database that would interfere with an existing entry to maintain that there is only zero or one single entry in the staging database that modifies any entry in the file database.

30. The method of claim 28, further comprising:
resolving discrepancies between an entry of the file in file database and the entry in the staging database that modifies the file once the changes have been made to the file.

31. The method of claim 19, further comprising:
synchronizing the file database with the cloud by requesting, downloading and processing a series of events sent by the cloud, wherein each of the events is a package of metadata describing a change to be synchronized with the cloud.

32. The method of claim 19, further comprising:
sending to the cloud and insert the local changes to the file as the second-to-most-recent revision in history of the file when the local changes are trampled by newer changes downloaded from the cloud before the local changes could be synchronized to the cloud.

33. The method of claim 23, further comprising:
caching none, some, or all parts of the file locally in the part store for access and editing by the user, wherein reference counts of the parts are updated based on an operation on an operation performed on the file by the user.

34. The method of claim 19, further comprising:
caching the file according to its caching policy, which is based on one or more of: how recently the file was accessed or modified, whether the file is currently open by the user, or if the user has flagged the file as having been requested to be permanently cached.

35. The method of claim 19, further comprising:
caching the file passively as storage allotment of the local computing device allows based on access or modify time of the file.
